(19) United States
(12) Patent Application Publication
(10) Pub. No.: US 2007/0143143 A1
(43) Pub. Date: Jun. 21, 2007

(54) Patient Discharge Data Processing System

(75) Inventors: Paul Villasenor, Newark, DE (US); Joseph Piccerillo JR., Phoenixville, PA (US); Patricia Wijtyk, Brookhaven, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/610,641

(22) Filed: Dec. 14, 2006

Related U.S. Application Data
(60) Provisional application No. 60/862,258, filed on Oct. 20, 2006.
(60) Provisional application No. 60/751,053, filed on Dec. 16, 2005.

(51) Int. Cl. G06Q 10/00; G06F 9/46

(52) U.S. Cl. 705/2; 719/318

(57) ABSTRACT

A system for managing patient discharge instruction preparation includes an interface for receiving data indicating a discharge date of a patient and a workflow processor. The workflow processor automatically, initiates communication of discharge task identification information to task lists associated with multiple different healthcare workers to initiate performance of discharge tasks by the workers, in response to the received discharge date data. The workflow processor automatically monitors a discharge instruction record to determine whether a particular discharge task has been completed by a predetermined time limit. Also in response to a determination the particular discharge task has not been completed within a predetermined time limit, the workflow processor automatically escalates notification indicating the particular discharge task remains to be performed by communication of information identifying the particular discharge task to a healthcare worker in response to a predetermined escalation hierarchy. In response to a determination the particular discharge tasks have been completed, the workflow processor automatically initiates communication of information to a healthcare worker indicating the discharge instruction record is complete and available for review.

This is a non-provisional application of provisional application Ser. No. 60/862,258 by P. Villasenor et al. filed Oct. 20, 2006 and provisional application Ser. No. 60/751,053 by P. Villasenor et al. filed Dec. 16, 2005.

### FIELD OF THE INVENTION

This invention concerns a system for managing patient discharge instruction preparation involving automatically monitoring and managing completion of a discharge instruction record for review.

### BACKGROUND OF THE INVENTION

This existing known systems, discharge instructions are typically completed for a patient either on paper or online and this may involve acquiring data from multiple users such as, one or more physicians or nurses, a physical therapist and a nutritionist, for example. As the number of users contributing to discharge instructions increases, so does the difficulty involved in coordinating these users, especially when a paper based discharge instruction completion process is used. Such a paper based process is constrained in that only one person can be working on the instructions at a time. Further, existing known paper or electronic systems rely on multiple healthcare workers completing discharge instructions in the form of a single document and these workers have no advanced knowledge of when the single document is ready for input by an individual worker.

The lack of advanced knowledge of when discharge instructions become available for input by individual workers, results in inefficiency and wasted time through users assigned to complete the instructions waiting for them to become available or because a user does not know the discharge instructions are ready for input. As a result, patient discharge becomes delayed. A system according to invention principles addresses these deficiencies and related problems.

### SUMMARY OF THE INVENTION

A system facilitates the collection of patient discharge instructions by allowing workers associated with the healthcare disciplines involved to contribute to the discharge instructions electronically in response to electronic notification and task scheduling. A system for managing patient discharge instruction preparation includes an interface for receiving data indicating a discharge date of a patient and a workflow processor. The workflow processor automatically, initiates communication of discharge task identification information to task lists associated with multiple different healthcare workers to initiate performance of discharge tasks by the workers, in response to the received discharge date data. The workflow processor automatically monitors a discharge instruction record to determine whether a particular discharge task has been completed by a predetermined time limit. Also in response to a determination the particular discharge task has not been completed within a predetermined time limit, the workflow processor automatically escalates notification indicating the particular discharge task remains to be performed by communication of information identifying the particular discharge task to a healthcare worker in response to a predetermined escalation hierarchy. In response to a determination the particular discharge tasks have been completed, the workflow processor automatically initiates communication of information to a healthcare worker indicating the discharge instruction record is complete and available for review.

### BRIEF DESCRIPTION OF THE DRAWING

FIG. 1 shows a Hospital Information System (HIS) including a system for managing patient discharge instruction preparation, according to invention principles.

FIG. 2 shows a flowchart of a process used by a system for managing patient discharge instruction preparation, according to invention principles.

FIG. 3 shows a user interface display image illustrating patient discharge instructions to be completed by healthcare workers, according to invention principles.

FIG. 4 shows a user interface display image for determining discharge activity instructions for a patient, according to invention principles.

FIG. 5 shows a user interface display image showing a list of tasks assigned to a worker including a discharge instruction completion task for a patient, according to invention principles.

FIG. 6 shows a flowchart of a process used by a system for managing patient discharge instruction preparation, according to invention principles.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of the executable procedure or executable application manipulates the UI display images in response to the signals received from the input devices. In this way, the user interacts with the display image using the input devices, enabling user interaction with the processor or other device. A workflow processor initiates and manages a sequence of tasks for performance by a worker, device or both such as in providing patient discharge instructions. The workflow processor provides data representing a task list of one or more workers and updates and manages the task list.

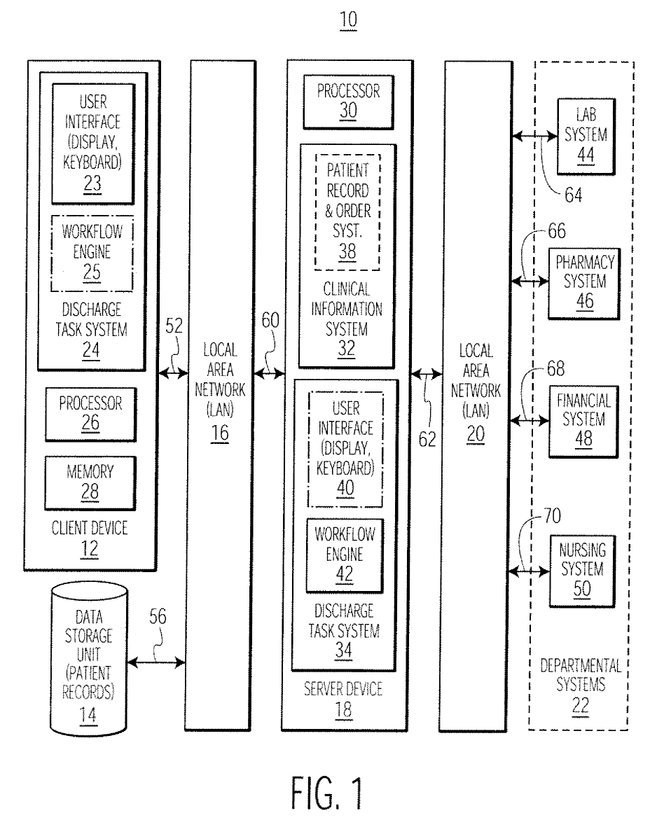

A system for managing patient discharge instruction preparation 34 in Hospital Information System (HIS) 10 (FIG. 1) combines an electronic documentation system with a workflow engine to coordinate actions by users in completing discharge instructions in a timely and efficient manner. The system facilitates the collection of patient discharge instructions in an acute or other care setting. System 34 streamlines completion of patient discharge instructions for use in enabling discharge of the patient from a hospital, for example and saves time by enabling a user to enter instruction data as early as upon admission of a patient to a hospital and to update it as needed. This reduces mistakes that occur in a conventional paper based system for preparation of paper discharge instructions and eliminates a need for a user to start again. Electronic system 34 saves user time because multiple users can enter data at the same time. Further, system 34 is workflow-enabled to provide a user involved in the completion of the discharge instructions with advance notification of a need for the user to enter data. This avoids a user from wasting time by prematurely attempting to enter data for discharge completion or in waiting to enter data.

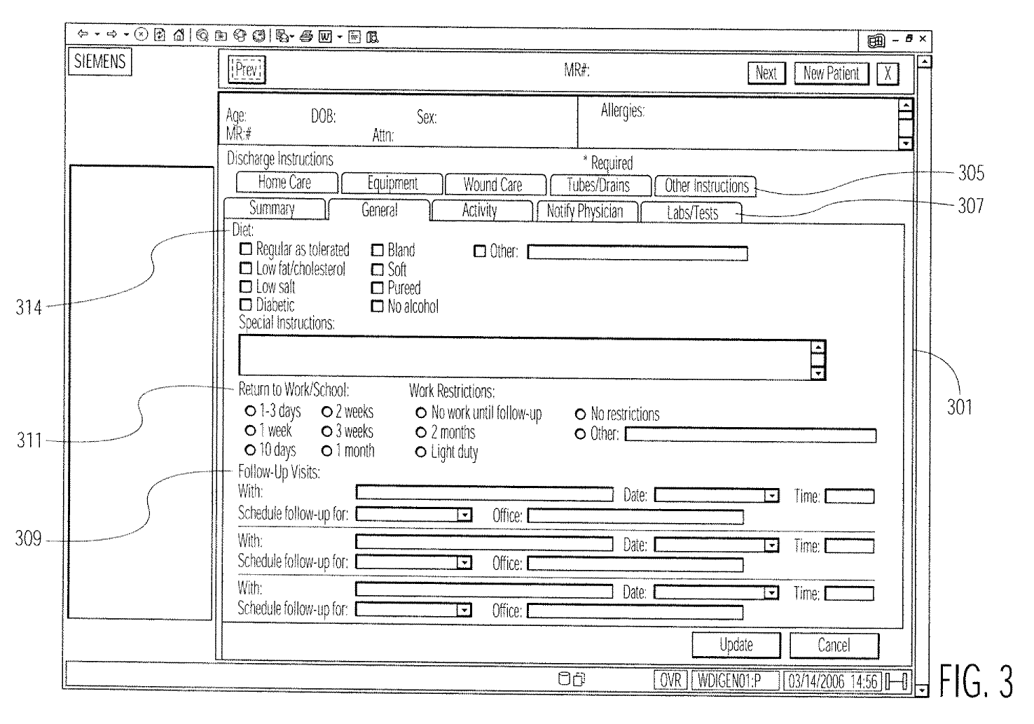

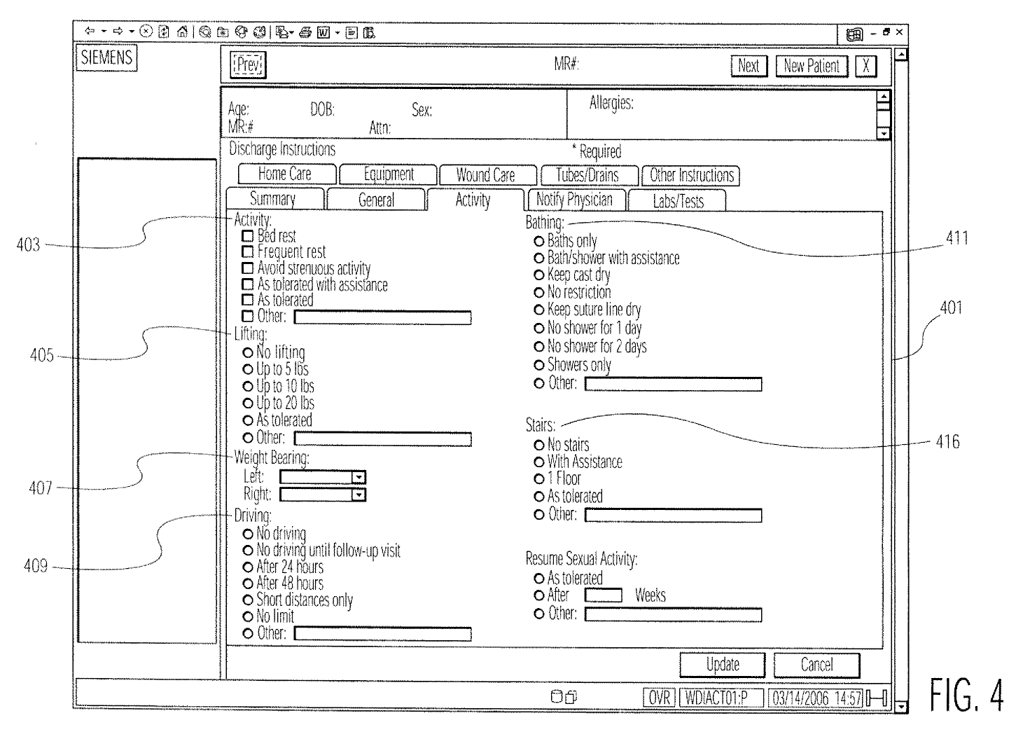

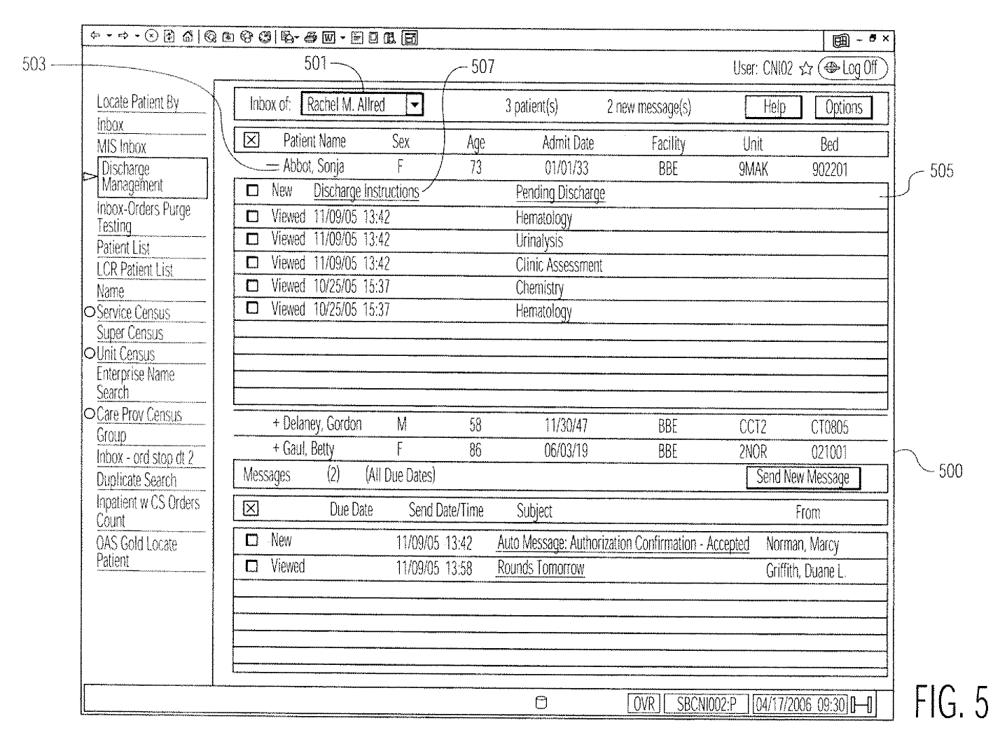

In system 10, clinical information system 32 includes a patient record management system and treatment order processing system 38. Discharge instruction preparation system 34 incorporates user interface 40 providing a display image including multi-image area data entry screens enabling multiple users to concurrently enter hospital discharge instructions. FIGS. 3 and 4 described later, illustrate user data collection images. The image areas are customizable for an individual hospital and include sections specific to different healthcare disciplines. In addition, discharge instruction preparation system 34 includes workflow processor (engine) 42 for managing worker task lists (worklists) and worker task notification. System 34 and workflow processor 42 informs users that worker specific data entry is required to provide discharge instructions for a particular patient. The appearance and format of displayed task lists is customizable and may vary for different implementations in different hospitals or departments, for example and the task lists provide a user a dynamically updated list of tasks to be performed by specific workers. System 34 also initiates communication of task identification data to a user via predetermined communication links such as via a pager, phone, or email. FIG. 5 described later, illustrates a task list indicating tasks to be performed by multiple different workers in providing discharge instructions for a patient.

Workflow processor 42 associates discharge instruction display images with worker task lists (and with a specific business process management system). FIG. 3 shows user interface display image 301 illustrating patient discharge instructions to be completed by healthcare workers. User selectable tabs to menus comprising different discharge instruction sections for completion by multiple different healthcare workers are shown in rows 305 and 307. Specifically, row 305 shows tabs to menus for home care, equipment, wound care, tubes/drains and other instruction sections for completion and row 307 shows tabs to menus for a summary, general, activity, physician notification and laboratory test instruction sections for completion. The highlighted tab in row 307 indicates the general discharge instruction section menu is selected and displayed. The general discharge instruction section includes a portion 309 for specifying patient follow up visits after discharge, a school or work related restriction and schedule portion 311 and a dietary portion 314.

FIG. 4 shows user interface display image menu 401 for determining discharge activity instructions for a patient. The activity discharge instruction section includes portion 403 for specifying permitted patient activity after discharge, portion 405 for specifying permitted patient lifting activity, portion 407 for specifying permitted patient weight bearing activity, portion 409 for specifying driving restrictions, portion 411 for specifying permitted patient bathing activity and portion 414 for specifying stair related restrictions, for example.

Workflow processor 42 communicates task information to particular users to inform the users that discharge instructions 301 (FIG. 3) for a particular patient are ready for data input by the particular users. FIG. 5 shows a user interface display image 500 showing a task list indicating tasks assigned to a worker (Rachel Allred 501) for a specific patient (Sonja Abbot 503). The menu is displayed upon logging into the system or by selecting the option to display the task list of user Rachel Allred 501. The example in FIG. 5 shows that the selected patient has a pending discharge and the discharge instructions task 505 need to be addressed. At this point, the user may click on the hyperlink 507 to go directly to the discharge instructions. The communication of task information to a task list advantageously facilitates timely completion of a discharge instruction document. Furthermore, workflow processor 42 is configurable to escalate task intervention to a worker in a predetermined hierarchy of supervisory workers by communicating data indicating overdue tasks to a selected supervisory worker so that an incomplete section of a discharge instruction document does not go ignored.

Discharge instruction preparation system 34 may alternatively be located in client device 12 as unit 24 (or elsewhere in a network employed by system 10). Discharge instruction preparation system 34 includes Rules Engine, Workflow processor (engine) and task scheduler 42 and user interface 40. Client device 12, preferably implemented as a personal computer, also includes a processor 26, and a memory unit 28. Processor 26 and memory unit 28 are constructed and operate in a manner well known to those skilled in the art of the design of client devices.

Discharge instruction preparation system 24 in client device 12 includes corresponding workflow engine 25 and user interface 23. Discharge instruction preparation system 34 employs structured user best practice rules in memory in clinical information system 32 that are automatically initiated when a discharge of a patient occurs. System 34 electronically communicates discharge instruction data in HL7 transaction format (or another format) to departmental systems 22, storage unit 14 and client device 12. System 10 maintains an audit record in unit 14 (or device 12) indicating changes made to a patient medical record and patient care including discharge instructions.

Healthcare information system 10 generally includes a client device 12, a data storage unit 14, a first local area network (LAN) 16, a server device 18, a second local area network (LAN) 20, and departmental systems 22. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

User interface 40 in discharge instruction preparation system 34 generally includes an input device that permits a user to input information and an output device that permits a user to receive information. Preferably, the input device is a keyboard and mouse, but also may be a touch screen or a microphone with a voice recognition program, for example. The output device is a display, but also may be a speaker, for example. The output device provides information to the user responsive to the input device receiving information from the user or responsive to other activity of the client device 12. For example, the display presents information responsive to the user entering information via the keyboard.

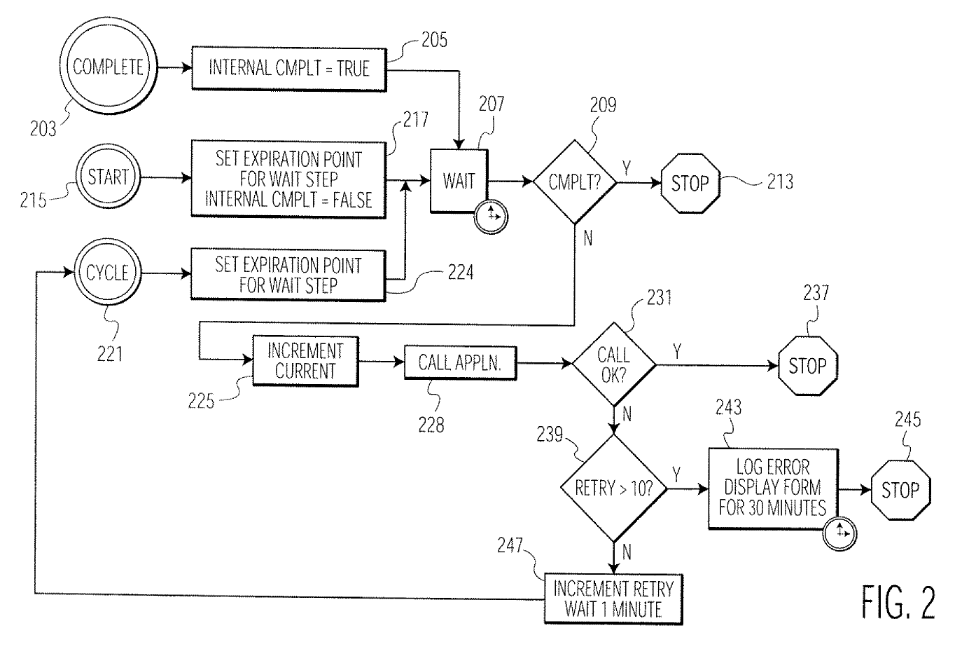

FIG. 2 shows a flowchart of a process used by discharge instruction preparation system 34 for managing, patient discharge instruction preparation. In step 205 following the start at step in step 203, system 34 monitors a discharge instruction completion indicator to determine if patient discharge instructions of the patient are complete. After a predetermined wait time determined in step 207, system 34 in step 209 again determines if the patient discharge instructions are complete based on one or more completion indicators or from a determination that required personnel have entered desired data. In another embodiment system 34 parses and examines discharge instructions for content to determine if the instructions have been completed. The process of FIG. 2 terminates at step 213 upon a determination the discharge instructions are complete.

A user employs system 34 in step 217 of FIG. 2 (after initiating a scan at step 215), to configure the predetermined wait time (of step 207) that the system waits for completion of patient discharge instructions before initiating further action. After a predetermined wait time determined in step 207, if system 34 in step 209 determines the patient discharge instructions are not complete based on one or more completion indicators or from a determination that required personnel have not entered desired data, system 34 increments a loop counter in step 225. Further, in step 228 system 34 initiates execution of an application for alerting a worker to enter discharge instruction data in an online instruction document (or escalates notification of a need to perform a discharge instruction data entry task of a particular worker to a supervisory worker if the loop count exceeds a predetermined threshold). In response to a determination the alert notification was successful in step 231, the process terminates in step 237. In response to a determination the task escalation notification was not successful in step 231 and if the loop count is determined to exceed a predetermined number such as 10 in step 239, system 34 in step 243 logs an error in an error record. System 34 also initiates communication of an error message for display for example, for a predetermined time (such as 30 minutes) and the process ends in step 245. If it is determined the loop count does not exceed the predetermined number in step 239, system 34 initiates a retry of the cycle in steps 247 and 221 following a delay (e.g., 1 minute). In step 224 system 34 adjusts wait lime in response to loop count (e.g., reduces wait time for increasing number of retries or alternatively leaves the time unaltered) and the process continues as previously described with a predetermined wait time in step 207 and determination of whether the patient discharge instructions in step 209 are complete until the FIG. 2 process terminates.

In illustration of operation, workflow processor 42 is notified of a projected discharge date and determines a patient is nearing the end of a hospital stay. The discharge date is projected either by user entry of a date into HIS 10 or by calculation by HIS 10 of the projected discharge date based on the admission date and a care plan for a specific disease, for example. Regardless of the way the information is entered, workflow processor 42 receives the date information and uses it as a reference point to determine when discharge instructions for the patient need to he completed. Workflow processor 42, a day before expected discharge, for example, initiates generation of a message for communication to a specific individual (or individuals) to query whether a patient is still scheduled to go home tomorrow. If so, processor 42 proceeds with notifications and escalations as scheduled. If not, processor 42 adjusts scheduling accordingly. The instructions may require input from workers including a physician, a nurse, a unit clerk, a case manager, a physical therapist, and a nutritionist, for example and these workers may not receive any communication indicating when a physician decides to discharge the patient. The absence of this communication results in delays in completing the instructions and in a known paper based instruction system may result in lack of availability of instruction forms.

In contrast, workflow processor 42 uses the projected discharge date as a target time and initiates the workflow process of FIG. 2 to manage the completion of electronic discharge instructions in a timely fashion. For example, once the projected discharge date is acquired and the discharge time is within a user configurable predetermined time window before the date, workflow processor 42 initiates communication of a task notification message for incorporation in task lists accessible by the physician, nurse, unit clerk, case manager, physical therapist, and nutritionist, and any other necessary personnel. The task notification message informs the nutritionist, for example, that the patient electronic discharge instructions require dietary instructions. Further, workflow processor 42 monitors the electronic discharge instructions for the dietary instructions to be valued, i.e., dietary instructions to be entered in the dietary section of the discharge instructions. In another embodiment workflow processor 42 monitors an indicator set by a nutritionist or by system 34 upon data entry by the nutritionist to indicate the dietary instructions are entered. System 34 similarly manages preparation of other sections of the discharge instructions for completion by a physician, nurse, unit clerk, case manager and physical therapist, for example.

Workflow processor 42 initiates task escalation (in step 228 of FIG. 2) by communication of an escalation message to a nurse or someone in a nutrition department so that a task does not continue to go unnoticed upon absence of entry of dietary instructions and expiration of a predetermined wait time (in steps 207 and 209). Workflow processor 42 continues to monitor the patient discharge instructions and again waits for the dietary instructions to be valued following communication of the escalation message. In response to a further absence of entry of dietary instructions and expiration of a predetermined wait time, workflow processor 42 again escalates the dietary instruction completion task according to a predetermined hierarchy to other individuals as needed until the task is complete.

Workflow processor 42 employs the process of FIG. 2 to manage completion of preparation of patient discharge instructions until the physician, the nurse, the unit clerk, the case manager, the physical therapist, and the nutritionist have individually completed their part of the discharge instructions. Workflow processor 42 detects discharge instruction completion and initiates communication of a message to the physician that the discharge instructions are ready for review and enables efficient processing and completion of the discharge instruction document. In contrast, existing known discharge instruction management systems typically fail to employ a workflow processor for coordination, management and initiation of communication supporting the discharge process.

System 34 enables a user of one of multiple user classes and occupying a specific role, to enter discharge relevant information into a discharge instruction document having authorization and access attributes assigned under administrator control to different document sections at any time during a patient stay. A user is able to enter several diagnoses and specify one diagnosis as primary and may at any time replace the current primary diagnosis with a new primary diagnosis or promote a secondary diagnosis to become a primary diagnosis. If a primary diagnosis is replaced, it automatically becomes a secondary diagnosis. The stored diagnoses coexist with billing codes and a user has an option to enter a free text diagnosis. System 34 further enables a user to enter follow-up appointment instructions that indicate contact information of a healthcare provider and may list a specific date and time or a time frame, e.g. “in two weeks”, for an appointment.

System 34 provides an ability to enter patient discharge instructions based on user-defined criteria. Instructions may include (but are not limited to) the following categories: diet, activity, weight bearing, lifting, driving, bathing, stairs, suture removal, return to work, outpatient labs, outpatient tests or procedures, IV Access, oxygen, special equipment and an “Other” category that comprises free text. The user is also able to conditionally collect data based on other criteria such as tubes, drains, ostomies, and wound/dressing care and other special care. The user is able to enter information for use by patients including conditions to look for (such as “fever,” “difficulty breathing,” etc.) and whom to contact (name and number) upon detection of a condition. The user is able to select multiple conditions and contact information selected from a predetermined list or to enter this information as free text. Contact information may include referring, primary care, and consulting physicians. The user also is able to enter special instructions as free text (e.g. “After 4:30 pm or on weekends call person A”)

System 34 supports access to documentation concerning patient consultations irrespective of whether or not it is associated with an order for treatment and provides a user with an option of entering consultation information as free text. The user is further able to review a list of patient treatment procedures at any time and to add or remove procedures at any time to provide a final list for the discharge documentation. System 34 enables a user to configure the content of discharge documentation for a particular hospital or individual department, for example, since some hospitals may require additional documents not used by other hospitals. A user is able to customize and save discharge document definitions and determine discharge documentation and its contents as they see fit using model discharge documentation templates. A user, for example, is able to save Discharge Instructions, a Discharge Face Sheet, Physician Discharge Orders, Interagency Transfer Form, etc.

User interface 40 provides specific display images to collect pertinent information that the patient will need to follow upon discharge and allows a user to select from an option list of sets of default instructions related to a patient diagnosis. The sets of default discharge instructions have a description that incorporates the diagnosis and physician preferences, for example, “pneumonia—Dr Smith” or “pneumonia—Group ABC”. An organization is able to define and edit individual sets of default instructions. For example, an orthopedic group may have a standard set of discharge instructions for patients with a total hip replacement (THR). Instead of inputting a complete set of instructions each time a THR patient is discharged, the user is able to modify standard THR discharge instructions and modify previously saved data and preview the discharge instructions as they are being generated.

System 34 enables a user to indicate a discharge instruction section is complete or the entire instructions are complete and disallow any further edits. Before finalizing, system 34 prompts the user to verify the documentation and validate that the user has the appropriate review and edit privileges. The user is not able to finalize documentation until predetermined criteria are met. System 34 keeps track of who finalized the documentation as well as who contributed to it using a date and time stamp to provide an audit trail that includes the user, the data entered, and the date and time stamp as well as a revision history and a chance log. The predetermined finalization criteria may require completion of certain data fields which may depend on other conditional fields. For example, if the user indicates that a patient has a drain that requires special care, the user is required to complete the instructions for drain care before being able to finalize the document. System 34 enables inclusion of a link to an online patient education library or to a clinical content provider where a patient may access pertinent information for the patient.

System 34 generates HealthLevel 7 (HL7) format compatible transaction messages conveying discharge instructions to other departmental systems 22. The other systems include a laboratory system 44, a hospital pharmacy system 46, a financial system 48 and a nursing system 50 and may further include an external pharmacy, a benefits administrator, an employer and other authorized systems (not shown to preserve drawing clarity). System 10 maintains an audit record in memory (e.g., in unit 14 or in device 18) indicating changes made to discharge instructions implementing industry best practices compatible with review organization (e.g., JCAHO) and national patient safety guidelines.

System 34 is preferably implemented in software, but may also be implemented in hardware or a combination of both. Further, any of the functions or activities performed by system 34 may be performed in response to user command in other embodiments. Data storage unit 14 stores patient records, as well as other information for the hospital information system 10. Patient records in the data storage unit 14 generally include any information related to a patient including, without limitation, biographical, financial, clinical, workflow, and care plan information.

The first local area network (LAN) 16 provides a communication network among the client device 12, the data storage unit 14 and the server device 18. The second local area network (LAN) 20 provides a communication network between the server device 18 and the depart mental systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol. The communication paths 52, 56, 60, 62, 64, 66, 68 and 70 each may be formed as a wired or wireless (W/WL) connection.

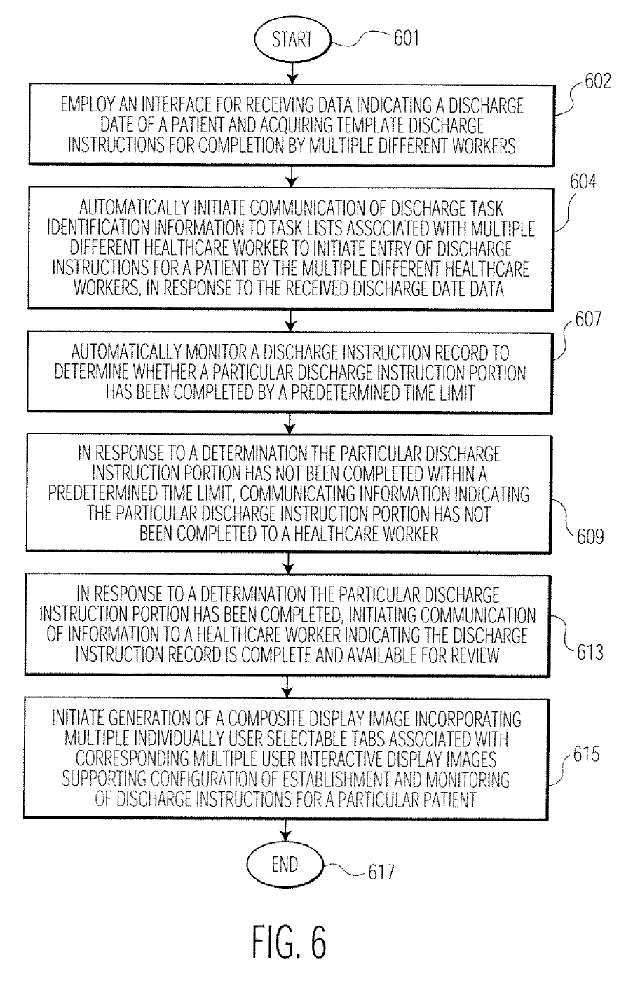

FIG. 6 shows a flowchart of a process used by system 34 (FIG. 1) for managing patient discharge instruction preparation. In step 602 following the start at step 601, an interface in unit 34 receives data indicating a discharge date of a patient and acquires template discharge instructions for completion by multiple different workers. The discharge date is a projected date derived from predetermined information indicating an estimated length of stay for a patient. The interface automatically acquires the template discharge instructions from a repository associating discharge instructions with a particular medical condition, in response to data indicating a medical condition of a patient. Alternatively, the interface automatically acquires the template discharge instructions from a repository associating discharge task identification information with at least one of, (a) a particular medical condition and (b) a particular treatment.

Workflow processor 42 in step 604 automatically initiates communication of discharge task identification information to task lists associated with multiple different healthcare workers occupying particular roles to initiate entry of discharge instructions and performance of discharge tasks for a patient by the multiple different healthcare workers, in response to the received discharge date data. The discharge tasks for performance by the multiple different healthcare workers may comprise completion of particular portions of discharge instructions or may comprise completion of particular treatment related procedures, for example. Workflow processor 42 acquires the discharge task identification information from a repository associating discharge task identification information with a particular medical condition or a particular treatment and acquires discharge instructions from a repository. The repository associates discharge instructions with at least one of (a) a patient having a particular medical condition and (b) a patient receiving a particular treatment. Workflow processor 42 identifies the multiple different healthcare workers from predetermined information indicating healthcare workers occupying roles for performing particular tasks for a particular patient or occupying roles associated with particular discharge tasks.

In step 607, workflow processor 42 automatically monitors a discharge instruction record to determine whether a particular discharge instruction portion and a particular discharge task has been completed by a predetermined time limit. In response to a determination the particular discharge instruction portion or discharge task has not been completed within a predetermined time limit, workflow processor 42 in step 609 communicates information indicating the particular discharge instruction portion or discharge task has not been completed to a healthcare worker occupying a particular role in response to a predetermined worker escalation hierarchy. Further, in response to a determination the particular discharge instruction portion or discharge task has been completed, workflow processor 42 in step 613 initiates communication of information to a healthcare worker occupying a particular role indicating the discharge instruction record (or discharge task documentation) is complete and available for review. User interface 40 in step 615 initiates generation of a composite display image incorporating multiple individually user selectable tabs associated with corresponding multiple user interactive display images supporting configuration of establishment and monitoring of discharge instructions for a particular patient. The process of FIG. 6 terminates at step 617.

The system, process and image menus of FIGS. 1-6 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may he implemented by those skilled in the art, without departing from the scope of the invention. Functions, processes or activities connected with FIGS. 1-6 may be performed automatically or alternatively, wholly or partially in response to manual interaction. A system for managing tasks according to invention principles is applicable in any fields where a need exists to have multiple users complete a single electronic form. Further, any of the functions and steps provided in FIGS. 1, 2 and 6 may be implemented in hardware, software or a combination of both and may reside on one or more processing devices located at any location of a network linking the FIG. 1 elements or another linked network including another intra-net or the Internet.

What is claimed is:

1. A system for managing patient discharge instruction preparation, comprising:
an interface for receiving data indicating a discharge date of a patient; and
a workflow processor for automatically,
initiating communication of discharge task identification information to task lists associated with a plurality of different healthcare workers to initiate performance of discharge tasks by said plurality of different healthcare workers, in response to said received discharge date data,
monitoring a discharge instruction record to determine whether a particular discharge task has been completed by a predetermined time limit,
in response to a determination said particular discharge task has not been completed within a predetermined time limit escalating notification indicating said particular discharge task remains to be performed by communication of information identifying said particular discharge task to a healthcare worker in response to a predetermined escalation hierarchy and
in response to a determination said particular discharge tasks have been completed, initiating communication of information to a healthcare worker indicating said discharge instruction record is complete and available for review.

2. A system according to claim 1, wherein
said discharge tasks for performance by said plurality of different healthcare workers comprise completion of particular portions of discharge instructions.

3. A system according to claim 1, wherein
said discharge tasks for performance by said plurality of different healthcare workers comprise completion of particular treatment related procedures.

4. A system according to claim 1, wherein
said discharge date is a projected date derived from predetermined information indicating an estimated length of stay for a patient.

5. A system according to claim 1, wherein
said workflow processor acquires said discharge task identification information from a repository associating discharge task identification information with at least one of (a) a particular medical condition and (b) a particular treatment.

6. A system according to claim 1, wherein
said workflow processor acquires discharge instructions from a repository associating discharge instructions with at least one of (a) a patient having a particular medical condition and (b) a patient receiving a particular treatment.

7. A system according to claim 1, wherein
said workflow processor identifies said plurality of different healthcare workers from predetermined information indicating healthcare workers occupying roles for performing particular tasks for a particular patient.

8. A system according to claim 1, wherein
said workflow processor identifies said plurality of different healthcare workers from predetermined information indicating healthcare workers occupying roles associated with particular discharge tasks.

9. A system according to claim 1, including
a user interface for initiating generation of a composite display image incorporating a plurality of individually user selectable tabs associated with a corresponding plurality of user interactive display images supporting configuration of establishment and monitoring of discharge instructions for a particular patient.

10. A system for managing patient discharge instruction preparation, comprising:
an interface for receiving data indicating a discharge date of a patient; and
a workflow processor for automatically, initiating communication of discharge task identification information to task lists associated with a plurality of different healthcare workers occupying particular roles to initiate entry of discharge instructions for a patient by said plurality of different healthcare workers, in response to said received discharge date data,
monitoring a discharge instruction record to determine whether a particular discharge instruction portion has been completed by a predetermined time limit,
in response to a determination said particular discharge instruction portion has not been completed within a predetermined time limit, communicating information indicating said particular discharge instruction portion has not been completed to a healthcare worker occupying a particular role in response to a predetermined worker escalation hierarchy and
in response to a determination said particular discharge instruction portion has been completed, initiating communication of information to a healthcare worker occupying a particular role indicating said discharge instruction record is complete and available for review.

11. A system for managing patient discharge instruction preparation, comprising:
an interface for receiving data indicating a discharge date of a patient and acquiring template discharge instructions for completion by a plurality of different workers: and
a workflow processor for automatically,
initiating communication of discharge task identification information to task lists associated with a plurality of different healthcare workers to initiate entry of discharge instructions for a patient by said plurality of different healthcare workers, in response to said received discharge date data,
monitoring a discharge instruction record to determine whether a particular discharge instruction portion has been completed by a predetermined time limit,
in response to a determination said particular discharge instruction portion has not been completed within a predetermined time limit, communicating information indicating said particular discharge instruction portion has not been completed to a healthcare worker and
in response to a determination said particular discharge instruction portion has been completed, initiating communication of information to a healthcare worker indicating said discharge instruction record is complete and available for review.

12. A system according to claim 11, wherein
said workflow processor communicates said information indicating said particular discharge instruction portion has not been completed in response to a predetermined worker escalation hierarchy.

13. A system according to claim 11, wherein
said interface automatically acquires said template discharge instructions from a repository associating discharge instructions with a particular medical condition, in response to data indicating a medical condition of a patient.

14. A system according to claim 11, wherein
said interface automatically acquires said template discharge instructions from a repository associating discharge instructions with a particular treatment, in response to data indicating a treatment of a patient.
